(19) United States
(12) Patent Application Publication
(10) Pub. No.: US 2025/0286739 A1
(43) Pub. Date: Sep. 11, 2025

(54) SYSTEMS AND METHODS FOR SCALABLE CRYPTOGRAPHIC AUTHENTICATION OF CONTACTLESS CARDS

(71) Applicant: Capital One Services, LLC, McLean, VA (US)

(72) Inventors: Kevin OSBORN, Newton Highlands, MA (US); Samuel Patrick EDWARDS, Richmond, VA (US)

(21) Appl. No.: 19/216,299

(22) Filed: May 22, 2025

Related U.S. Application Data
(63) Continuation of application No. 17/353,556, filed on Jun. 21, 2021, now Pat. No. 12,335,412.

(51) Int. Cl. H04L 9/32; H04L 9/14; H04L 9/30; H04L 9/40

(52) U.S. Cl. CPC H04L 9/3271; H04L 9/30; H04L 63/0435; H04L 63/0492; H04L 9/14

(57) ABSTRACT

Systems and methods for authentication may include an authentication server. The authentication server may include a processor and a memory. The processor may be configured to transmit an authentication request. The processor may be configured to receive a first response that is responsive to the authentication request, the first response comprising a first cryptogram. The processor may be configured to generate a first challenge based on the first response. The processor may be configured to encrypt the first challenge with a symmetric key. The processor may be configured to transmit the first challenge receive a second response that is responsive to the first challenge, the second response comprising a second cryptogram. The processor may be configured to authenticate the second response.

### CROSS-REFERENCE TO RELATED APPLICATION

This patent application is a continuation of U.S. patent application Ser. No. 17/353,556, filed Jun. 21, 2021, the contents of which are incorporated herein by reference in their entirety.

### FIELD OF THE DISCLOSURE

The present disclosure relates to systems and methods for scalable cryptographic authentication of contactless cards.

### BACKGROUND

Card-based transactions are becoming increasingly common. These transactions often involve the use of a card in communication with a point of sale device, a server, or other device. It is necessary to protect such communications from interception and unauthorized access.

However, transmission of data without encryption or other protection is susceptible to phishing attacks, and replay attacks, and may be subject to other vulnerabilities, resulting in increased security risks and increased risks of account or card misuse. These risks may be further increased through the use of contactless cards, which communicate with other devices wirelessly.

Measures taken to address security risk may consume system resources and hinder operational efficiency. For large numbers of transactions, the consumption of system resources and the hindrance of transaction efficiency can increase, which may result in a failure to perform transactions or unsatisfactory performance.

These and other deficiencies exist. Accordingly, there is a need for systems and methods for authentication that overcome these deficiencies by protecting communications from interception and unauthorized access in a secure and reliable manner.

### SUMMARY OF THE DISCLOSURE

Embodiments of the present disclosure provide an authentication server. The authentication server may include a processor and a memory. The processor may be configured to transmit an authentication request. The processor may be configured to receive a first response that is responsive to the authentication request, the first response comprising a first cryptogram. The processor may be configured to generate a first challenge based on the first response. The processor may be configured to encrypt the first challenge with a symmetric key. The processor may be configured to transmit the first challenge receive a second response that is responsive to the first challenge, the second response comprising a second cryptogram. The processor may be configured to authenticate the second response.

Embodiments of the present disclosure provide a method of authentication. The method may include transmitting an authentication request. The method may include receiving a first response that is responsive to the authentication request, the first response comprising a first cryptogram. The method may include generating a first challenge based on the first response. The method may include encrypting the first challenge with a symmetric key. The method may include transmitting the first challenge. The method may include receiving a second response that is responsive to the first challenge, the second response comprising a second cryptogram. The method may include authenticating the second response.

Embodiments of the present disclosure provide a computer readable non-transitory medium comprising computer executable instructions that, when executed on a processor, perform procedures comprising the steps of: transmitting an authentication request; receiving a first response that is responsive to the authentication request, the first response comprising a first cryptogram; generating a first challenge based on the first response; encrypting the first challenge with a symmetric key; transmitting the first challenge; receiving a second response that is responsive to the first challenge, the second response comprising a second cryptogram; and authenticating the second response.

### BRIEF DESCRIPTION OF THE DRAWINGS

Various embodiments of the present disclosure, together with further objects and advantages, may best be understood by reference to the following description taken in conjunction with the accompanying drawings.

FIG. 1 depicts an authentication server according to an exemplary embodiment.

FIG. 2A is an illustration of a contactless card according to an exemplary embodiment.

FIG. 2B is an illustration of a contact pad of a contactless card according to an exemplary embodiment.

FIG. 3 depicts a method of authentication according to an exemplary embodiment.

FIG. 4 depicts a sequence diagram of a process for authentication according to an exemplary embodiment.

FIG. 5 depicts a method of authentication according to an exemplary embodiment.

FIG. 6 depicts a method of authentication according to an exemplary embodiment.

### DETAILED DESCRIPTION

The following description of embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

Benefits of the systems and methods disclosed herein include improved authentication by protecting communications from interception and unauthorized access. The systems and methods disclosed herein allow for the avoidance of phishing attacks, preventing replay attacks through encrypted data communications, and the reduction of other security vulnerabilities.

In addition, challenges may be generated and corresponding responses may be transmitted via customized commands to improve authentication. By doing so, security risks can be further mitigated and transaction efficiency can be improved.

These features can be implemented without degrading the user experience by burdening the user with unnecessary security tasks. Further, these features can be performed in a manner that allows for the time-efficient performance of transactions, in order to comply with user expectations and transaction requirements.

Additionally, the systems and methods described herein are scalable, allowing for use with a large number of transactions. By doing so, large numbers of transactions can be performed in a timely and satisfactory manner, while maintaining transaction efficiency and efficient use of system resources.

Accordingly, the systems and methods disclosed herein reduce the risk of fraudulent activity, such as misuse of the card or an account associated with the card, and address authentication implementations that lack scalability, while promoting transaction efficiency and avoiding degradation of the user experience. Unlike conventional systems that rely on using a limited number of random keys and a successful registration, the systems and methods disclosed herein allow for producing and reproducing a significant number, such as in the millions, of keys by using key diversification. Furthermore, card issuance advantageously provides information relevant for identification and authentication.

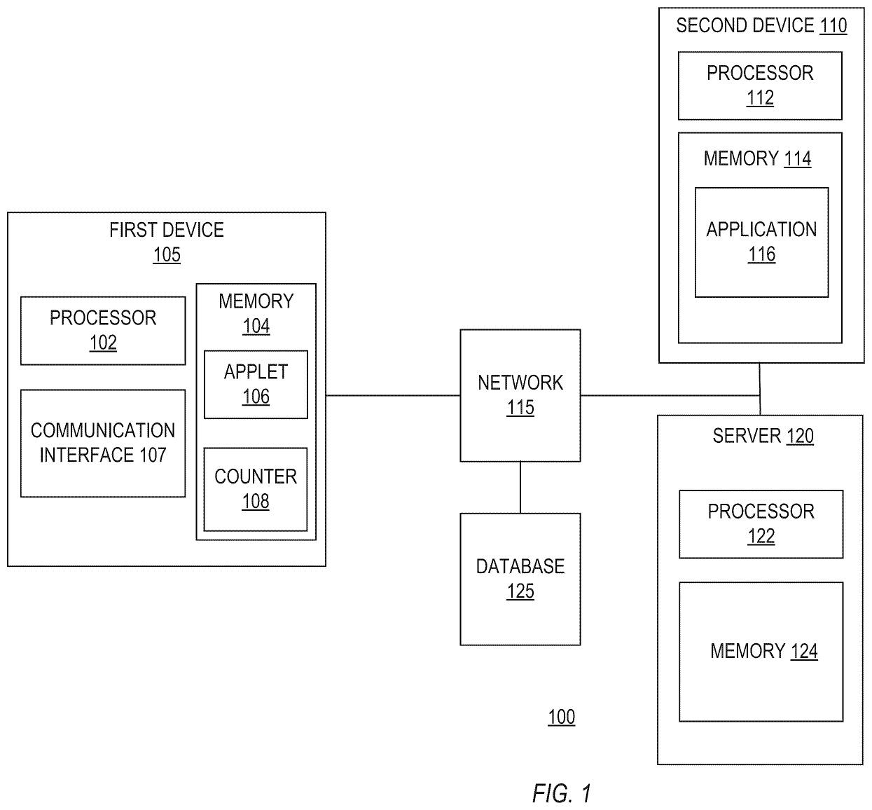

FIG. 1 illustrates an authentication system 100. The system 100 may comprise a first device 105, a second device 110, a network 115, a server 120, and a database 125. Although FIG. 1 illustrates single instances of components of system 100, system 100 may include any number of components.

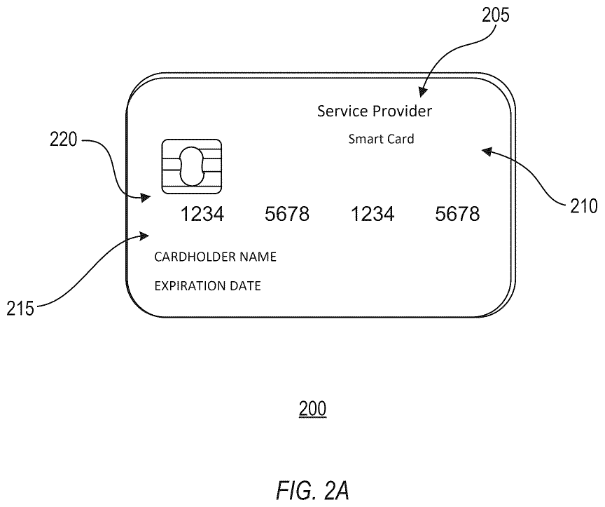

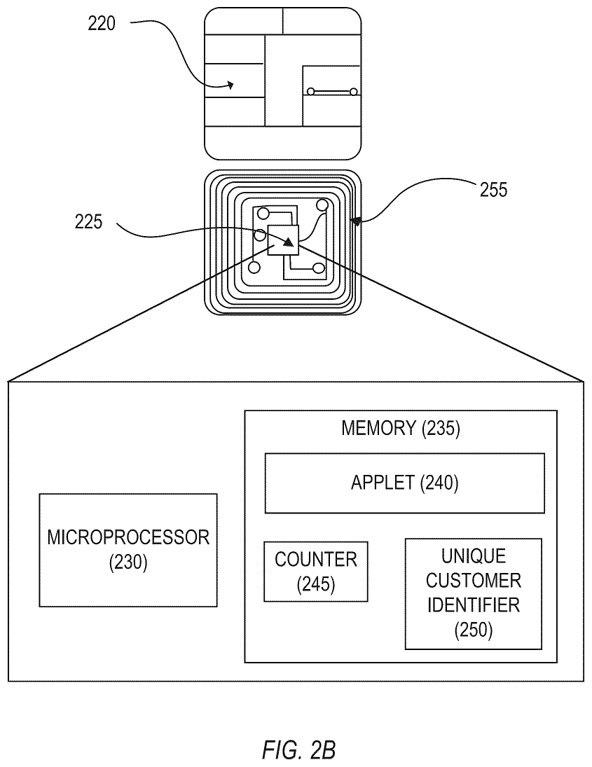

System 100 may include a first device 105. The first device 105 may comprise a contactless card, a contact-based card, a network-enabled computer, or other device described herein. As referred to herein, a network-enabled computer may include, but is not limited to a computer device or communications device including, e.g., a server, a network appliance, a personal computer, a workstation, a phone, a handheld PC, a personal digital assistant, a contactless card, a thin client, a fat client, an Internet browser, a kiosk, a tablet, a terminal, or other device. As further explained below in FIGS. 2A-2B, first device 105 may include one or more processors 102, and memory 104. Memory 104 may include one or more applets 106 and one or more counters 108. Each counter 108 may include a counter value. Memory 104 may include the counter value, transmission data, and at least one key.

First device 105 may include a communication interface 107. The communication interface 107 may comprise communication capabilities with physical interfaces and contactless interfaces. For example, the communication interface 107 may be configured to communicate with a physical interface, such as by swiping through a card swipe interface or inserting into a card chip reader found on an automated teller machine (ATM) or other device configured to communicate over a physical interface. In other examples, the communication interface 107 may be configured to establish contactless communication with a card reading device via a short-range wireless communication method, such as NFC, Bluetooth, Wi-Fi, RFID, and other forms of contactless communication. As shown in FIG. 1, the communication interface 107 may be configured to communicate directly with the second device 110, server 120, and/or database 125 via network 115.

First device 105 may be in data communication with any number of components of system 100. For example, first device 105 may transmit data via network 115 to second device 110, and/or server 120. First device 105 may transmit data via network 115 to database 125. In some examples, first device 105 may be configured to transmit data via network 115 after entry into one or more communication fields of any device. Without limitation, each entry may be associated with a tap, a swipe, a wave, and/or any combination thereof.

System 100 may include a second device 110. The second device 110 may include one or more processors 112, and memory 114. Memory 114 may include one or more applications, including but not limited to application 116. Second device 110 may be in data communication with any number of components of system 100. For example, second device 110 may transmit data via network 115 to server 120. Second device 110 may transmit data via network 115 to database 125. Without limitation, second device 110 may be a network-enabled computer. Second device 110 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The second device 110 may include processing circuitry and may contain additional components, including processors, memories, error and parity/CRC checkers, data encoders, anticollision algorithms, controllers, command decoders, security primitives and tamperproofing hardware, as necessary to perform the functions described herein. The second device 110 may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touch-screen, keyboard, mouse, cursor-control device, touch-screen, microphone, digital camera, video recorder or camcorder. These devices may be used to enter information and interact with the software and other devices described herein.

System 100 may include a network 115. In some examples, network 115 may be one or more of a wireless network, a wired network or any combination of wireless network and wired network, and may be configured to connect to any one of components of system 100. For example, first device 105 may be configured to connect to server 120 via network 115. In some examples, network 115 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, network 115 may include, without limitation, telephone lines, fiber optics, IEEE Ethernet 902.3, a wide area network, a wireless personal area network, a LAN, or a global network such as the Internet. In addition, network 115 may support an Internet network, a wireless communication network, a cellular network, or the like, or any combination thereof. Network 115 may further include one network, or any number of the exemplary types of networks mentioned above, operating as a stand-alone network or in cooperation with each other. Network 115 may utilize one or more protocols of one or more network elements to which they are communicatively coupled. Network 115 may translate to or from other protocols to one or more protocols of network devices. Although network 115 is depicted as a single network, it should be appreciated that according to one or more examples, network 115 may comprise a plurality of interconnected networks, such as, for example, the Internet, a service provider's network, a cable television network, corporate networks, such as credit card association networks, and home networks.

System 100 may include one or more servers 120. In some examples, server 120 may include one or more processors 122 coupled to memory 124. Server 120 may be configured as a central system, server or platform to control and call various data at different times to execute a plurality of workflow actions. Server 120 may be configured to connect to first device 105. Server 120 may be in data communication with the applet 106 and/or application 116. For example, a server 120 may be in data communication with applet 106 via one or more networks 115. First device 105 may be in communication with one or more servers 120 via one or more networks 115, and may operate as a respective front-end to back-end pair with server 120. First device 105 may transmit, for example from applet 106 executing thereon, one or more requests to server 120. The one or more requests may be associated with retrieving data from server 120. Server 120 may receive the one or more requests from first device 105. Based on the one or more requests from applet 106, server 120 may be configured to retrieve the requested data. Server 120 may be configured to transmit the received data to applet 106, the received data being responsive to one or more requests.

In some examples, server 120 can be a dedicated server computer, such as bladed servers, or can be personal computers, laptop computers, notebook computers, palm top computers, network computers, mobile devices, wearable devices, or any processor-controlled device capable of supporting the system 100. While FIG. 1 illustrates a single server 120, it is understood that other embodiments can use multiple servers or multiple computer systems as necessary or desired to support the users and can also use back-up or redundant servers to prevent network downtime in the event of a failure of a particular server.

Server 120 may include an application comprising instructions for execution thereon. For example, the application may comprise instructions for execution on the server 120. The application of the server 120 may be in communication with any components of system 100. For example, server 120 may execute one or more applications that enable, for example, network and/or data communications with one or more components of system 100 and transmit and/or receive data. Without limitation, server 120 may be a network-enabled computer. Server 120 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The server 120 may include processing circuitry and may contain additional components, including processors, memories, error and parity/CRC checkers, data encoders, anticollision algorithms, controllers, command decoders, security primitives and tamperproofing hardware, as necessary to perform the functions described herein. The server 120 may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touch-screen, keyboard, mouse, cursor-control device, touch-screen, microphone, digital camera, video recorder or camcorder. These devices may be used to enter information and interact with the software and other devices described herein.

System 100 may include one or more databases 125. The database 125 may comprise a relational database, a non-relational database, or other database implementations, and any combination thereof, including a plurality of relational databases and non-relational databases. In some examples, the database 125 may comprise a desktop database, a mobile database, or an in-memory database. Further, the database 125 may be hosted internally by any component of system 100, such as the first device 105 or server 120, or the database 125 may be hosted externally to any component of the system 100, such as the first device 105 or server 120, by a cloud-based platform, or in any storage device that is in data communication with the first device 105 and server 120. In some examples, database 125 may be in data communication with any number of components of system 100. For example, server 120 may be configured to retrieve the requested data from the database 125 that is transmitted by applet 106. Server 120 may be configured to transmit the received data from database 125 to applet 106 via network 115, the received data being responsive to the transmitted one or more requests. In other examples, applet 106 may be configured to transmit one or more requests for the requested data from database 125 via network 115.

In some examples, exemplary procedures in accordance with the present disclosure described herein can be performed by a processing arrangement and/or a computing arrangement (e.g., computer hardware arrangement). Such processing/computing arrangement can be, for example entirely or a part of, or include, but not limited to, a computer/processor that can include, for example one or more microprocessors, and use instructions stored on a computer-accessible medium (e.g., RAM, ROM, hard drive, or other storage device). For example, a computer-accessible medium can be part of the memory of the first device 105, second device 110, server 120, and/or database 125, or other computer hardware arrangement.

In some examples, a computer-accessible medium (e.g., as described herein above, a storage device such as a hard disk, floppy disk, memory stick, CD-ROM, RAM, ROM, etc., or a collection thereof) can be provided (e.g., in communication with the processing arrangement). The computer-accessible medium can contain executable instructions thereon. In addition or alternatively, a storage arrangement can be provided separately from the computer-accessible medium, which can provide the instructions to the processing arrangement so as to configure the processing arrangement to execute certain exemplary procedures, processes, and methods, as described herein above, for example.

The server 120 may be configured to transmit a first request. For example, the first request may comprise an authentication request. The application 116 of the client device 110 may be configured to receive the first request. The application 116 of the client device 110 may be configured to conduct one or more reads of the first device 105, such as the card. For example, the application 116 may be configured to conduct a read, such as a near field communication read, of a tag of the card 105.

The one or more processors 102 of card 105 may be configured to create a cryptogram using at least one key and a counter value. The cryptogram may include the counter value and the transmission data. The one or more processors 102 of card 105 may be configured to transmit the first cryptogram. The one or more processors 102 of card 105 may be configured to transmit, after entry into one or more communication fields of any device, data responsive to the read, such as a first read. For example, the one or more processors 102 of card 105 may be configured to transmit, after a first entry into a first communication field of the device, the first cryptogram. Without limitation, each entry may be associated with a tap, a swipe, a wave, and/or any combination thereof. The first cryptogram may be received, upon request, via a near field communication data exchange format (NDEF) read. The one or more processors 102 of card 105 may be configured to transmit the first cryptogram. The application 116 of the client device 110 may be configured to receive the first cryptogram and a public key from a response transmitted by the one or more processors 102 of the card 105. In some examples, the one or more processors 102 of the card 105 may be configured to generate and transmit, to the application 116 of the client device 110, the first cryptogram using a shared secret. In some examples, the response may comprise a first response. The first response may be generated based on a first read of the tag of the card 105. The first response may also comprise a version number associated with the card 105. In some examples, the one or more processors 102 of the card 105 may be configured to encrypt the first cryptogram prior to its transmission. For example, the first response may include any combination of a unique identifier of the card 105, a counter 108, a version number of the card 105 that allows for changes in the one or more cryptographic algorithms used, and the first cryptogram that serves as a Message Authentication Code (MAC). In some examples, the first response may comprise a public key digital signature. In other examples, the first response may comprise a MAC inside encrypt structure using one or more symmetric, or derived session, keys. For example, the card 105 may be configured to generate a plurality of session keys, such as a first session key and a second session key, using secret keys combined with the counter 108 of the card 105. The MAC may be generated with the first session key. The MAC may be encrypted with the second session key prior to its transmission for decryption and validation. In some examples, if a public key is also used for subsequent challenge validation, such as challenge validation by the server 120, the public key may be transmitted by the card 105 in the clear or unencrypted, or alternatively the public key may be encrypted along with the MAC prior to transmission from the card 105. In addition, the message used in MAC construction may also include one or more shared secrets for further security. The server 120 may be configured to generate unique derived keys using the unique identifier and master keys. The server 120 may be configured to generate session keys from the unique derived keys and the counter. The server 120 may be configured to decrypt the encrypted MAC from the first cryptogram. The server 120 may be configured to validate the MAC using the session key.

The one or more processors 102 may be configured to transmit the first cryptogram via the communication interface 107. For example, the one or more processors 102 may be configured to transmit the first cryptogram to one or more applications. In some examples, the one or more processors 102 may be configured to transmit the first cryptogram to an application 116 comprising instructions for execution on a second device 110. The one or more processors 102 may be configured to update the counter value after transmission of the first cryptogram.

In some examples, the server 120 may be configured to receive the first cryptogram and the public key from a response transmitted by the one or more processors 102 of card 105. The application 116 of the client device 110 may be configured to transmit the first cryptogram and the public key from the response by the card 105 to the server 120. The server 120 may be configured to decrypt the first cryptogram.

The server 120 may be configured to, based on the first response, generate a first challenge. The server 120 may be configured to encrypt the first challenge with a key, such as a symmetric key. The server 120 may be configured to transmit the encrypted first challenge to the application 116 of the client device 110. In some examples, the server 120 may be configured to transmit the encrypted first challenge based on the version number received from the card 105 or the application 116 of the device 110. Moreover, the server 120 may be configured to generate a random number, such as a secret salt, that is associated with a transaction and also included with the transmitted first challenge. The random number may be generated by the server 120 and may be unique for each transaction. For example, the random number may comprise a string of bits with high entropy. In some examples, the random number may serve as an additional component in the MAC calculation, and include any length. In other examples, the random number may be the same length as the message for combining, such as the one or more logical operations including but not limited to, AND, OR, XOR, NOT.

The first challenge may be associated with a first predetermined time duration. Thus, the first challenge may be time-limited. For example, the server 120 may be configured to generate, after expiration of the first predetermined time duration, one or more additional challenges that are each associated with respective predetermined time durations. For example, the server 120 may be configured to generate, after expiration of the first predetermined time duration, a second challenge associated with a second predetermined time duration. In this manner, a new encrypted challenge associated with a predetermined time duration may be generated and transmitted so as to allow a limited time for decryption.

For example, the first challenge may be combined with a unique identifier of the card 105, a counter of the card 105, and one or more logical operations, including but not limited to, AND, OR, XOR, NOT. In some examples, the first challenge may be encrypted with one or more symmetric keys. For example, the card 105 may include its own symmetric key that is also known by the server 120, or may be derived via key diversification. In some examples, one or more unique derived keys may be generated based on combining one or more secret master keys with the unique identifier of the card 105. In both the card 105 and the server 120, the symmetric key may be independently derived from a master key, and thus the master key and the symmetric key may never be transmitted. In other examples, the first challenge may be encrypted by a private key of the card 105, in which a transmitted public key may be configured to decrypt the first challenge that was encrypted by the private key. In this manner, one or more additional challenges may be encrypted according to these various implementations.

Regarding the key diversification, and without limitation, the card 105 may include a card key, such as a diversified master key, and the server 120 may include its own server key, such as a master key. The card 105 may be configured to generate a diversified key using the diversified master key, one or more cryptographic algorithms, and a counter value. The card 105 may be configured to generate a cryptographic result including the counter value using the one or more cryptographic algorithms and the diversified key. The card 105 may be configured to encrypt transmission data using the one or more cryptographic algorithms and the diversified key to yield encrypted transmission data. The encrypted transmission data and cryptographic result may be transmitted, for example to server 120, by the card 105 for decryption.

The server 120 may be configured to generate an authentication diversified key based on the server master key and a unique identifier. The server 120 may be configured to generate a session key based on the authentication diversified key. The server 120 may be configured to decrypt encrypted transmission data and validate the received cryptographic result using the one or more cryptographic algorithms and the session key.

In some examples, the server 120 may be configured to generate the first challenge based on one or more factors. For example, the one or more factors may include a version number returned in the first read, and a determination of a predetermined type of transaction. For example, the first challenge may be generated based on the version number obtained in the first read. For example, the server 120 may be configured to determine if a transaction associated with the authentication request is a high-risk transaction. The server 120 may be configured to determine if the transaction is high-risk based on evaluation of one or more parameters, including one or more selected from the group of account data, transaction history data, transaction amount, previous time stamps associated with same or similar transactions, prior user authentication attempts and results, abnormal or suspicious geographic locations, abnormal or suspicious merchants, merchants with previous fraudulent activity, and/or any combination thereof.

The application 116 of the client device 110 may be configured to transmit the encrypted first challenge as part of command-application protocol data unit (C-APDU) to the card 105. The one or more processors 102 of the card 105 may be configured to decrypt the encrypted first challenge received from the application 116 of the client device 110. In some examples, the first challenge may be unencrypted and transmitted by the application 116 of the client device 110, and received by the one or more processors 102 of the card 105. The one or more processors 102 of the card 105 may be configured to combine the first challenge with one or more private card keys in such a manner that either a secret key holder, such as the server 120 associated with an issuer of the card 105, may validate that it was combined correctly or via public key verification. When the first challenge is encrypted, the one or more processors 102 of the card 105 may be configured to transmit the decrypted first challenge to the application 116 of the client device 110 as part of a response-application protocol data unit (R-APDU). The response may be a second response and comprise a second cryptogram that incorporates the first challenge into the calculation, which may be combined with the one or more private card keys or as part of the message being signed. The one or more processors 102 of the card 105 may be configured to encrypt the second cryptogram prior to its transmission. The response may also include the random number, such as the secret salt, that is transmitted for verification by comparison with a reference random number or secret salt by the server 120. In some examples, the one or more processors 102 of the card 105 may be configured to perform one or more logical operations, such as an XOR, of the random number with the response prior to the encryption of the second cryptogram. The one or more processors 102 of the card 105 may be configured to transmit, after entry into one or more communication fields of any device, data, such as the second cryptogram. For example, the one or more processors 102 of the card 105 may be configured to transmit, after a second entry into a first communication field of the device, the second cryptogram to the application 116 of second device 110. Without limitation, each entry may be associated with a tap, a swipe, a wave, and/or any combination thereof.

The server 120 may be configured to receive the second response including the second cryptogram from the one or more processors 102 of the card 105. In some examples, the server 120 may be configured to receive the second response including the second cryptogram from the application 116 of the client device 110. The server 120 may be configured to authenticate the second response by validating the second cryptogram. For example, the server 120 may be configured to decrypt the second cryptogram. Based on a determination of an outcome of the decryption of the second cryptogram, the server 120 may be configured to transmit one or more results to the application 116 of the client device 110.

In some examples, the server 120 may be configured to transmit a successful authentication message if the second cryptogram is validated. For example, the server 120 may be configured to transmit the successful authentication message to the application 116 of the client device 110. In other examples, the server 120 may be configured to transmit an unsuccessful authentication message if the second cryptogram is not validated. For example, the server 120 may be configured to transmit the unsuccessful authentication message to the application 116 of the client device 110. If the second cryptogram is not validated, the server 120 may terminate the authentication process. In another example, the server 120 may be configured to resume the authentication process by, without limitation, resending the authentication request, or generating and encrypting and transmitting a different challenge.

FIG. 2A illustrates one or more first devices 200. First device 200 may reference the same or similar components of first device 105, as explained above with respect to FIG. 1. Although FIGS. 2A and 2B illustrate single instances of components of first device 200, any number of components may be utilized.

First device 200 may be configured to communicate with one or more components of system 100. First device 200 may comprise a contact-based card or contactless card, which may comprise a payment card, such as a credit card, debit card, or gift card, issued by a service provider 205 displayed on the front or back of the contactless card 200. In some examples, the contactless card 200 is not related to a payment card, and may comprise, without limitation, an identification card, a membership card, and a transportation card. In some examples, the payment card may comprise a dual interface contactless payment card. The contactless card 200 may comprise a substrate 210, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 200 may have physical characteristics compliant with the ID-1 format of the ISO/IEC 7810 standard, and the contactless card may otherwise be compliant with the ISO/IEC 14443 standard. However, it is understood that the contactless card 200 according to the present disclosure may have different characteristics, and the present disclosure does not require a contactless card to be implemented in a payment card.

The contactless card 200 may also include identification information 215 displayed on the front and/or back of the card, and a contact pad 220. The contact pad 220 may be configured to establish contact with another communication device, including but not limited to a user device, smart phone, laptop, desktop, or tablet computer. The contactless card 200 may also include processing circuitry, antenna and other components not shown in FIG. 2A. These components may be located behind the contact pad 220 or elsewhere on the substrate 210. The contactless card 200 may also include a magnetic strip or tape, which may be located on the back of the card (not shown in FIG. 2A).

As illustrated in FIG. 2B, the contact pad 220 of FIG. 2A may include processing circuitry 225 for storing and processing information, including a processor 230, such as a microprocessor, and a memory 235. It is understood that the processing circuitry 225 may contain additional components, including processors, memories, error and parity/CRC checkers, data encoders, anticollision algorithms, controllers, command decoders, security primitives and tamperproofing hardware, as necessary to perform the functions described herein.

The memory 235 may be a read-only memory, write-once read-multiple memory or read/write memory, e.g., RAM, ROM, and EEPROM, and the contactless card 200 may include one or more of these memories. A read-only memory may be factory programmable as read-only or one-time programmable. One-time programmability provides the opportunity to write once then read many times. A write once/read-multiple memory may be programmed at a point in time after the memory has left the factory. Once the memory is programmed, it may not be rewritten, but it may be read many times. A read/write memory may be programmed and re-programed many times after leaving the factory. It may also be read many times.

The memory 235 may be configured to store one or more applets 240, one or more counters 245, and a customer identifier 250. The one or more applets 240 may comprise one or more software applications configured to execute on one or more contactless cards, such as Java Card applet. However, it is understood that applets 240 are not limited to Java Card applets, and instead may be any software application operable on contactless cards or other devices having limited memory. The one or more counters 245 may comprise a numeric counter sufficient to store an integer. The customer identifier 250 may comprise a unique alphanumeric identifier assigned to a user of the contactless card 200, and the identifier may distinguish the user of the contactless card from other contactless card users. In some examples, the customer identifier 250 may identify both a customer and an account assigned to that customer and may further identify the contactless card associated with the customer's account.

The processor and memory elements of the foregoing exemplary embodiments are described with reference to the contact pad, but the present disclosure is not limited thereto. It is understood that these elements may be implemented outside of the contact pad 220 or entirely separate from it, or as further elements in addition to processor 230 and memory 235 elements located within the contact pad 220.

In some examples, the contactless card 200 may comprise one or more antennas 255. The one or more antennas 255 may be placed within the contactless card 200 and around the processing circuitry 225 of the contact pad 220. For example, the one or more antennas 255 may be integral with the processing circuitry 225 and the one or more antennas 255 may be used with an external booster coil. As another example, the one or more antennas 255 may be external to the contact pad 220 and the processing circuitry 225.

In an embodiment, the coil of contactless card 200 may act as the secondary of an air core transformer. The terminal may communicate with the contactless card 200 by cutting power or amplitude modulation. The contactless card 200 may infer the data transmitted from the terminal using the gaps in the contactless card's power connection, which may be functionally maintained through one or more capacitors. The contactless card 200 may communicate back by switching a load on the contactless card's coil or load modulation. Load modulation may be detected in the terminal's coil through interference.

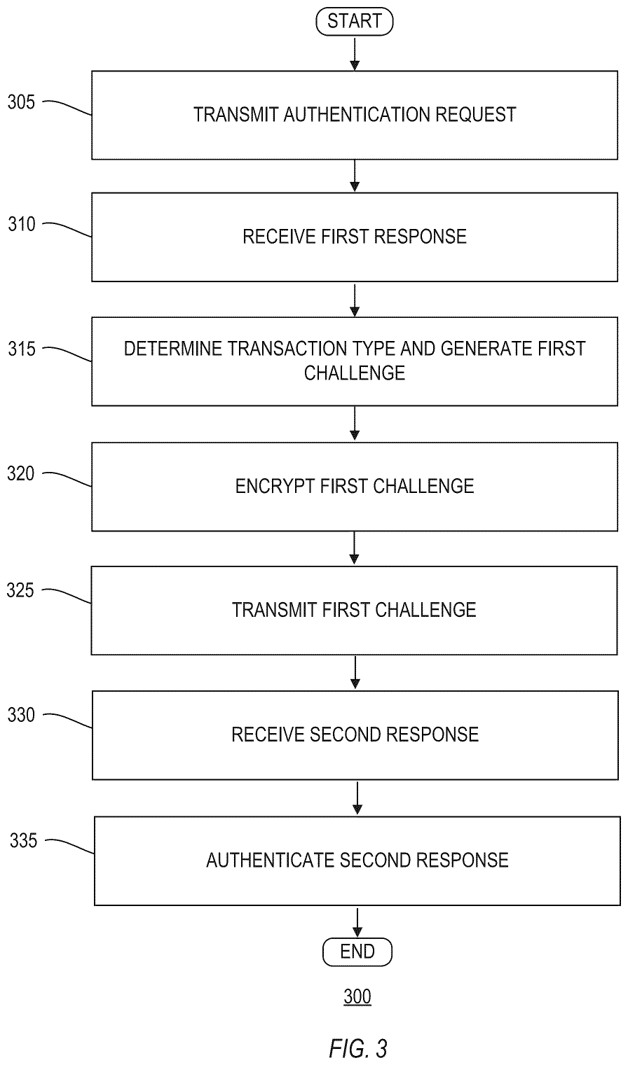

FIG. 3 depicts a method 300 of authentication. FIG. 3 may reference the same or similar components of system 100, and first device 200 of FIG. 2A and FIG. 2B.

At block 305, the method 300 may include transmitting an authentication request. For example, the first request may comprise an authentication request. The application of the client device may be configured to receive the first request. The server may be configured to transmit the authentication request to the application of the client device. The application of the client device may be configured to conduct one or more reads of the card. For example, the application may be configured to conduct a read, such as a near field communication read, of a tag of the card.

At block 310, the method 300 may include receiving a first response that is responsive to the authentication request, the first response comprising a first cryptogram. For example, the card may be configured to transmit the first cryptogram as part of a first response. The card may be configured to transmit, after entry into one or more communication fields of any device, data responsive to the read, such as a first read. For example, the card may be configured to transmit, after a first entry into a first communication field of the device, the first cryptogram. Without limitation, each entry may be associated with a tap, a swipe, a wave, and/or any combination thereof. The first device or card may create the cryptogram using at least one key and a counter value. For example, one or more processors of the card may be configured to create a cryptogram using the at least one key and the counter value. The cryptogram may include the counter value and the transmission data. The card may include a memory containing one or more keys, including the at least one key, a counter value, and the transmission data. The card may further include a communication interface. The first cryptogram may be received, responsive to the authentication request, via a near field communication data exchange format (NDEF) read. The card may be configured to transmit the first cryptogram. The application of the client device may be configured to receive the first cryptogram and a public key from a response transmitted by the card. In some examples, the one or more processors of the card may be configured to generate and transmit, to the application of the client device, the first cryptogram using a shared secret. In some examples, the response may comprise a first response. The first response may be generated based on a first read of the tag of the card. The first response may also comprise a version number associated with the card. In some examples, the card may be configured to encrypt the first cryptogram prior to its transmission. For example, the first response may include any combination of a unique identifier of the card, a counter, a version number of the card that allows for changes in the one or more cryptographic algorithms used, and the first cryptogram that serves as a MAC. In some examples, the first response may comprise a public key digital signature. In other examples, the first response may comprise a MAC inside encrypt structure using one or more symmetric, or derived session, keys. For example, the card may be configured to generate a plurality of session keys, such as a first session key and a second session key, using secret keys combined with the counter of the card. The MAC may be generated with the first session key. The MAC may be encrypted with the second session key prior to its transmission for decryption and validation. In some examples, if a public key is also used for subsequent challenge validation, such as challenge validation by the server, the public key may be transmitted by the card in the clear or unencrypted, or alternatively the public key may be encrypted along with the MAC prior to transmission from the card. In addition, the message used in MAC construction may also include one or more shared secrets for further security. The server may be configured to generate unique derived keys using the unique identifier and master keys. The server may be configured to generate session keys from the unique derived keys and the counter. The server may be configured to decrypt the encrypted MAC from the first cryptogram. The server may be configured to validate the MAC using the session key.

In some examples, the server may be configured to receive the first cryptogram and the public key from a response transmitted by the card. The application of the client device may be configured to transmit the first cryptogram and the public key from the response by the card to the server. The server may be configured to decrypt the first cryptogram.

At block 315, the method 300 may include generating a first challenge based on the first response. For example, the server may be configured to, based on the first response, generate a first challenge. Moreover, the server may be configured to generate a random number, such as a secret salt, that is associated with a transaction and also included with the transmitted first challenge. The random number may be generated by the server and may be unique for each transaction. For example, the random number may comprise a string of bits with high entropy. In some examples, the random number may serve as an additional component in the MAC calculation, and include any length. In other examples, the random number may be the same length as the message for combining, such as the one or more logical operations including but not limited to, AND, OR, XOR, NOT.

In some examples, the server may be configured to generate the first challenge based on one or more factors. For example, the one or more factors may include a version number returned in the first read, and a determination of a predetermined type of transaction. For example, the first challenge may be generated based on the version number obtained in the first read. For example, the server may be configured to determine if a transaction associated with the authentication request is a high-risk transaction. The server may be configured to determine if the transaction is high-risk based on evaluation of one or more parameters, including one or more selected from the group of account data, transaction history data, transaction amount, previous time stamps associated with same or similar transactions, prior user authentication attempts and results, abnormal or suspicious geographic locations, abnormal or suspicious fraudulent merchants, and/or any combination thereof.

The first challenge may be associated with a first predetermined time duration. Thus, the first challenge may be time-limited. For example, the server may be configured to generate, after expiration of the first predetermined time duration, one or more additional challenges that are each associated with respective predetermined time durations. For example, the server may be configured to generate, after expiration of the first predetermined time duration, a second challenge associated with a second predetermined time duration. In this manner, a new encrypted challenge associated with a predetermined time duration may be generated and transmitted so as to allow a limited time for decryption.

At block 320, the method 300 may include encrypting the first challenge with a symmetric key. The server may be configured to encrypt the first challenge with a key, such as a symmetric key. In other examples, the application of the device may be configured to encrypt the first challenge with the key. For example, the first challenge may be combined with a unique identifier of the card, a counter of the card, and one or more logical operations, including but not limited to, AND, OR, XOR, NOT. In some examples, the first challenge may be encrypted with one or more symmetric keys. For example, the card may include its own symmetric key that is also known by the server, or may be derived via key diversification. In some examples, one or more unique derived keys may be generated based on combining one or more secret master keys with the unique identifier of the card. In both the card and the server, the symmetric key may be independently derived from a master key, and thus the master key and the symmetric key may never be transmitted. In other examples, the first challenge may be encrypted by a private key of the card, in which a transmitted public key may be configured to decrypt the first challenge that was encrypted by the private key.

Regarding the key diversification, and without limitation, the card may include a card key, such as a diversified master key, and the server may include its own server key, such as a master key. The card may be configured to generate a diversified key using the diversified master key, one or more cryptographic algorithms, and a counter value. The card may be configured to generate a cryptographic result including the counter value using the one or more cryptographic algorithms and the diversified key. The card may be configured to encrypt transmission data using the one or more cryptographic algorithms and the diversified key to yield encrypted transmission data. The encrypted transmission data and cryptographic result may be transmitted, for example to server, by the card for decryption.

The server may be configured to generate an authentication diversified key based on the server master key and a unique identifier. The server may be configured to generate a session key based on the authentication diversified key. The server may be configured to decrypt encrypted transmission data and validate the received cryptographic result using the one or more cryptographic algorithms and the session key.

At block 325, the method 300 may include transmitting the first challenge. For example, the server may be configured to transmit the encrypted first challenge to the application of the client device. In some examples, the server may be configured to transmit the encrypted first challenge based on the version number received from the card or the application of the device. In some examples, the application of the client device may be configured to transmit the encrypted first challenge as part of command-application protocol data unit (C-APDU) to the card.

At block 330, the method 300 may include receiving a second response that is responsive to the first challenge, the second response comprising a second cryptogram. For example, the server may be configured to receive the second response including the second cryptogram from the card. In some examples, the server may be configured to receive the second response including the second cryptogram from the application of the client device. The card may be configured to decrypt the encrypted first challenge received from the application of the client device. In some examples, the first challenge may be unencrypted and transmitted by the application of the client device, and received by the one or more processors of the card. The one or more processors of the card may be configured to combine the first challenge with one or more private card keys in such a manner that either a secret key holder, such as the server associated with an issuer of the card, may validate that it was combined correctly or via public key verification. When the first challenge is encrypted, the card may be configured to transmit the decrypted first challenge to the application of the client device as part of a response-application protocol data unit (R-APDU). The response may be a second response and comprise a second cryptogram that incorporates the first challenge into the calculation, which may be combined with the one or more private card keys or as part of the message being signed. The card may be configured to encrypt the second cryptogram prior to its transmission. The response may also include the random number, such as the secret salt, that is transmitted for verification by comparison with a reference random number or secret salt by the server. In some examples, the card may be configured to perform one or more logical operations, e.g., AND, OR, XOR, NOT, of the random number with the response prior to the cryptogram encryption. The card may be configured to transmit, after entry into one or more communication fields of any device, data, such as the second cryptogram. For example, the card may be configured to transmit, after a second entry into a first communication field of the device, the second cryptogram. Without limitation, each entry may be associated with a tap, a swipe, a wave, and/or any combination thereof.

At block 335, the method 300 may include authenticating the second response. For example, the server may be configured to authenticate the second response by validating the second cryptogram. For example, the server may be configured to decrypt the second cryptogram. Based on a determination of an outcome of the decryption of the second cryptogram, the server may be configured to transmit one or more results to the application of the client device.

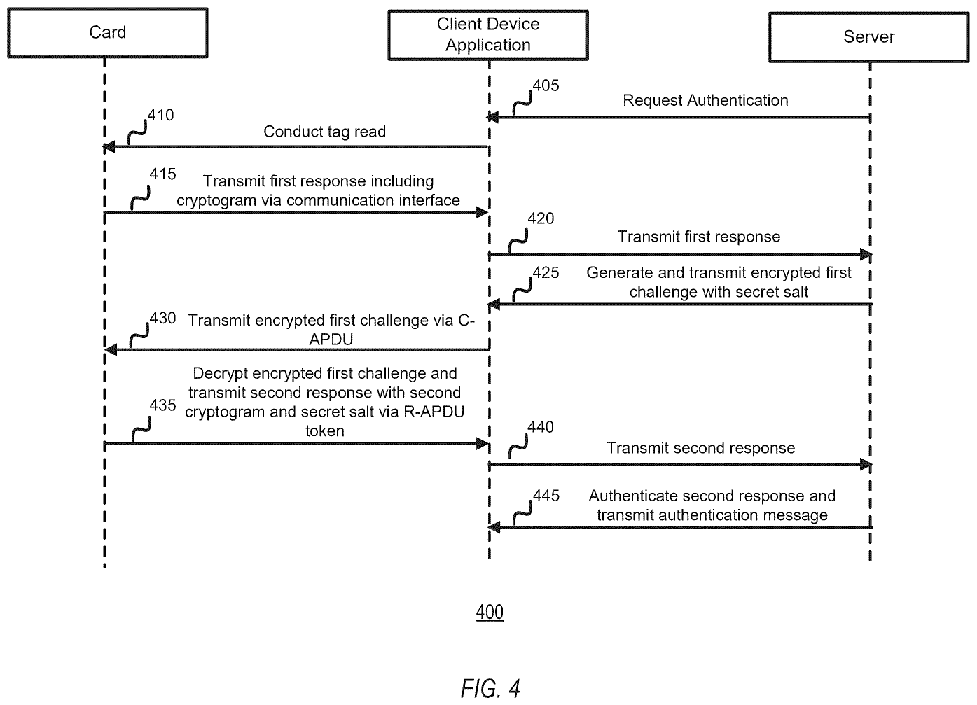

FIG. 4 depicts a sequence diagram 400 of a process for authentication according to an exemplary embodiment. FIG. 4 may reference the same or similar components of system 100, first device 200 of FIG. 2A and FIG. 2B, and method 300 of FIG. 3.

At step 405, a server may be configured to transmit a first request. For example, the first request may comprise an authentication request. An application of a client device may be configured to receive the first request. At step 410, the application of the client device may be configured to conduct one or more reads of a card as part of the first request. For example, the application may be configured to conduct a read, such as a near field communication read, of a tag of the card.

At step 415, the card may be configured to transmit the first cryptogram. The card may be configured to transmit, after entry into one or more communication fields of any device, data responsive to the read, such as a first read, via a communication interface. For example, the card may be configured to transmit, after a first entry into a first communication field of the device, the first cryptogram. Without limitation, each entry may be associated with a tap, a swipe, a wave, and/or any combination thereof. The application of the client device may be configured to receive the first cryptogram and a public key from a response transmitted by the card. In some examples, the one or more processors of the card may be configured to generate and transmit, to the application of the client device, the first cryptogram using a shared secret. In some examples, the response may comprise a first response. The first response may be generated based on a first read of the tag of the card. The first response may also comprise a version number associated with the card. In some examples, the card may be configured to encrypt the first cryptogram prior to its transmission. For example, the first response may include any combination of a unique identifier of the card, a counter, a version number of the card that allows for changes in the one or more cryptographic algorithms used, and the first cryptogram that serves as a MAC. In some examples, the first response may comprise a public key digital signature. In other examples, the first response may comprise a MAC inside encrypt structure using one or more symmetric, or derived session, keys. For example, the card may be configured to generate a plurality of session keys, such as a first session key and a second session key, using secret keys combined with the counter of the card. The MAC may be generated with the first session key. The MAC may be encrypted with the second session key prior to its transmission for decryption and validation. In some examples, if a public key is also used for subsequent challenge validation, such as challenge validation by the server, the public key may be transmitted by the card in the clear or unencrypted, or alternatively the public key may be encrypted along with the MAC prior to transmission from the card. In addition, the message used in MAC construction may also include one or more shared secrets for further security. The server may be configured to generate unique derived keys using the unique identifier and master keys. The server may be configured to generate session keys from the unique derived keys and the counter. The server may be configured to decrypt the encrypted MAC from the first cryptogram. The server may be configured to validate the MAC using the session key.

At step 420, the application of the client device may be configured to transmit the first cryptogram and the public key from the response by the card to the server. In some examples, the server may be configured to receive the first cryptogram and the public key from a response transmitted by the card. The server may be configured to decrypt the first cryptogram.

The server may be configured to, based on the first response, generate a first challenge. The server may be configured to encrypt the first challenge with a key, such as a symmetric key. Moreover, the server may be configured to generate a random number, such as a secret salt, that is associated with a transaction and also included with the transmitted first challenge. The random number may be generated by the server and may be unique for each transaction. For example, the first challenge may be combined with a unique identifier of the card, a counter of the card, and one or more logical operations, including but not limited to, AND, OR, XOR, NOT. In some examples, the first challenge may be encrypted with one or more symmetric keys. For example, the card may include its own symmetric key that is also known by the server, or may be derived via key diversification. In some examples, one or more unique derived keys may be generated based on combining one or more secret master keys with the unique identifier of the card. In both the card and the server, the symmetric key may be independently derived from a master key, and thus the master key and the symmetric key may never be transmitted. In other examples, the first challenge may be encrypted by a private key of the card, in which a transmitted public key may be configured to decrypt the first challenge that was encrypted by the private key.

Regarding the key diversification, and without limitation, the card may include a card key, such as a diversified master key, and the server may include its own server key, such as a master key. The card may be configured to generate a diversified key using the diversified master key, one or more cryptographic algorithms, and a counter value. The card may be configured to generate a cryptographic result including the counter value using the one or more cryptographic algorithms and the diversified key. The card may be configured to encrypt transmission data using the one or more cryptographic algorithms and the diversified key to yield encrypted transmission data. The encrypted transmission data and cryptographic result may be transmitted, for example to server, by the card for decryption.

The server may be configured to generate an authentication diversified key based on the server master key and a unique identifier. The server may be configured to generate a session key based on the authentication diversified key. The server may be configured to decrypt encrypted transmission data and validate the received cryptographic result using the one or more cryptographic algorithms and the session key.

The first challenge may be associated with a first predetermined time duration. Thus, the first challenge may be time-limited. For example, the server may be configured to generate, after expiration of the first predetermined time duration, one or more additional challenges that are each associated with respective predetermined time durations. For example, the server may be configured to generate, after expiration of the first predetermined time duration, a second challenge associated with a second predetermined time duration. In this manner, a new encrypted challenge associated with a predetermined time duration may be generated and transmitted so as to allow a limited time for decryption.

In some examples, the server may be configured to generate the first challenge based on one or more factors. For example, the one or more factors may include a version number returned in the first read, and a determination of a predetermined type of transaction. For example, the first challenge may be generated based on the version number obtained in the first read. For example, the server may be configured to determine if a transaction associated with the authentication request is a high-risk transaction. The server may be configured to determine if the transaction is high-risk based on evaluation of one or more parameters, including one or more selected from the group of account data, transaction history data, transaction amount, previous time stamps associated with same or similar transactions, prior user authentication attempts and results, abnormal or suspicious geographic locations, abnormal or suspicious fraudulent merchants, and/or any combination thereof.

At step 425, the server may be configured to transmit the encrypted first challenge to the application of the client device. In some examples, the server may be configured to transmit the encrypted first challenge based on the version number received from the card or the application of the device. The application of the client device may be configured to receive the encrypted first challenge from the server.

At step 430, the application of the client device may be configured to transmit the encrypted first challenge as part of command-application protocol data unit (C-APDU) to the card.

At step 435, the card may be configured to decrypt the encrypted first challenge received from the application of the client device. In some examples, the first challenge may be unencrypted and transmitted by the application of the client device, and received by the one or more processors of the card. The one or more processors of the card may be configured to combine the first challenge with one or more private card keys in such a manner that either a secret key holder, such as the server associated with an issuer of the card, may validate that it was combined correctly or via public key verification. When the first challenge is encrypted, the card may be configured to transmit the decrypted first challenge to the application of the client device as part of a response-application protocol data unit (R-APDU). The response may be a second response and comprise a second cryptogram that incorporates the first challenge into the calculation, which may be combined with the one or more private card keys or as part of the message being signed. The card may be configured to encrypt the second cryptogram prior to its transmission. The response may also include the random number, such as the secret salt, that is transmitted for verification by comparison with a reference random number or secret salt by the server. In some examples, the card may be configured to perform one or more logical operations, e.g., AND, OR, XOR, NOT, of the random number with the response prior to the encryption of the second cryptogram. The card may be configured to transmit, after entry into one or more communication fields of any device, data, such as the second cryptogram. For example, the card may be configured to transmit, after a second entry into a first communication field of the device, the second cryptogram. Without limitation, each entry may be associated with a tap, a swipe, a wave, and/or any combination thereof.

At step 440, the server may be configured to receive the second response including the second cryptogram. In some examples, the server may be configured to receive the second response including the second cryptogram from the application of the client device. The server may be configured to authenticate the second response by validating the second cryptogram. For example, the server may be configured to decrypt the second cryptogram. Based on a determination of an outcome of the decryption of the second cryptogram, the server may be configured to transmit one or more results to the application of the client device.

At step 445, the server may be configured to transmit a successful authentication message if the second cryptogram is validated. For example, the server may be configured to transmit the successful authentication message to the application of the client device. In other examples, the server may be configured to transmit an unsuccessful authentication message if the second cryptogram is not validated. For example, the server may be configured to transmit the unsuccessful authentication message to the application of the client device. If the second cryptogram is not validated, the server may terminate the authentication process. In another example, the server may be configured to resume the authentication process by, without limitation, resending the authentication request, or generating and encrypting and transmitting a different challenge.

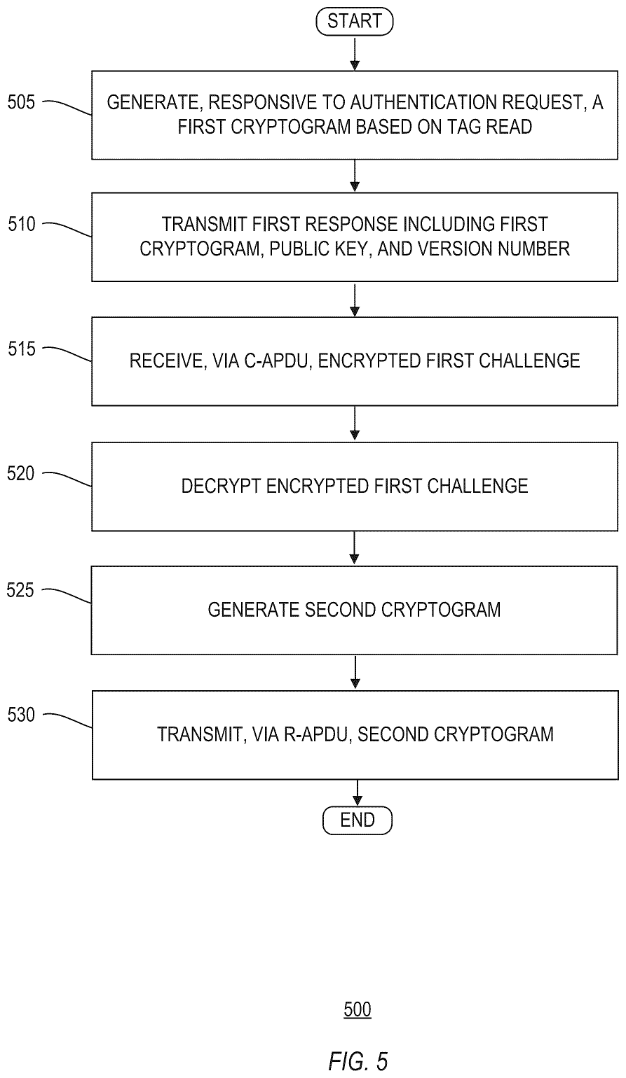

FIG. 5 depicts a method of 500 of authentication according to an exemplary embodiment. FIG. 5 may reference the same or similar components of system 100, first device 200 of FIG. 2A and FIG. 2B, method 300 of FIG. 3, and sequence diagram 400 of FIG. 4.

At block 505, the method 500 may include generating, in response to an authentication request, a first cryptogram based on a read of a tag. For example, an application of the client device may be configured to conduct one or more reads of the card. For example, the application may be configured to conduct a read, such as a near field communication read, of a tag of the card.

At block 510, the method 500 may include transmitting a first response including the first cryptogram and a public key and a version number. The first cryptogram may be received, upon request, via a near field communication data exchange format (NDEF) read. The card may be configured to transmit the first cryptogram. The card may be configured to transmit, after entry into one or more communication fields of any device, data responsive to the read, such as a first read. For example, the card may be configured to transmit, after a first entry into a first communication field of the device, the first cryptogram. In some examples, the one or more processors of the card may be configured to generate and transmit, to the application of the client device, the first cryptogram using a shared secret. Without limitation, each entry may be associated with a tap, a swipe, a wave, and/or any combination thereof. The first response may be generated based on a first read of the tag of the card. The first response may also comprise a version number associated with the card. In some examples, the card may be configured to encrypt the first cryptogram prior to its transmission. For example, the first response may include any combination of a unique identifier of the card, a counter, a version number of the card that allows for changes in the one or more cryptographic algorithms used, and the first cryptogram that serves as a MAC. In some examples, the first response may comprise a public key digital signature. In other examples, the first response may comprise a MAC inside encrypt structure using one or more symmetric, or derived session, keys. For example, the card may be configured to generate a plurality of session keys, such as a first session key and a second session key, using secret keys combined with the counter of the card. The MAC may be generated with the first session key. The MAC may be encrypted with the second session key prior to its transmission for decryption and validation. In some examples, if a public key is also used for subsequent challenge validation, such as challenge validation by the server, the public key may be transmitted by the card in the clear or unencrypted, or alternatively the public key may be encrypted along with the MAC prior to transmission from the card. In addition, the message used in MAC construction may also include one or more shared secrets for further security. The server may be configured to generate unique derived keys using the unique identifier and master keys. The server may be configured to generate session keys from the unique derived keys and the counter. The server may be configured to decrypt the encrypted MAC from the first cryptogram. The server may be configured to validate the MAC using the session key.

At block 515, the method 500 may include receiving, via a command-application protocol data unit (C-APDU), an encrypted first challenge. For example, a server may be configured to, based on the received and authenticated first response, generate a first challenge. The server may be configured to decrypt the first cryptogram transmitted by the card. The server may be configured to encrypt the first challenge with a key, such as a symmetric key. For example, the first challenge may be combined with a unique identifier of the card, a counter of the card, and one or more logical operations, including but not limited to, AND, OR, XOR, NOT. In some examples, the first challenge may be encrypted with one or more symmetric keys. For example, the card may include its own symmetric key that is also known by the server, or may be derived via key diversification. In some examples, one or more unique derived keys may be generated based on combining one or more secret master keys with the unique identifier of the card. In both the card and the server, the symmetric key may be independently derived from a master key, and thus the master key and the symmetric key may never be transmitted. In other examples, the first challenge may be encrypted by a private key of the card, in which a transmitted public key may be configured to decrypt the first challenge that was encrypted by the private key.

Regarding the key diversification, and without limitation, the card may include a card key, such as a diversified master key, and the server may include its own server key, such as a master key. The card may be configured to generate a diversified key using the diversified master key, one or more cryptographic algorithms, and a counter value. The card may be configured to generate a cryptographic result including the counter value using the one or more cryptographic algorithms and the diversified key. The card may be configured to encrypt transmission data using the one or more cryptographic algorithms and the diversified key to yield encrypted transmission data. The encrypted transmission data and cryptographic result may be transmitted, for example to server, by the card for decryption.

The server may be configured to generate an authentication diversified key based on the server master key and a unique identifier. The server may be configured to generate a session key based on the authentication diversified key. The server may be configured to decrypt encrypted transmission data and validate the received cryptographic result using the one or more cryptographic algorithms and the session key.

The server may be configured to transmit the encrypted first challenge to the application of the client device. In some examples, the server may be configured to transmit the encrypted first challenge based on the version number received from the card or the application of the device. Moreover, the server may be configured to generate a random number, such as a secret salt, that is associated with a transaction and also included with the transmitted first challenge. The random number may be generated by the server and may be unique for each transaction. For example, the random number may comprise a string of bits with high entropy. In some examples, the random number may serve as an additional component in the MAC calculation, and include any length. In other examples, the random number may be the same length as the message for combining, such as the one or more logical operations including but not limited to, AND, OR, XOR, NOT.

The first challenge may be associated with a first predetermined time duration. Thus, the first challenge may be time-limited. For example, the server may be configured to generate, after expiration of the first predetermined time duration, one or more additional challenges that are each associated with respective predetermined time durations. For example, the server may be configured to generate, after expiration of the first predetermined time duration, a second challenge associated with a second predetermined time duration. In this manner, a new encrypted challenge associated with a predetermined time duration may be generated and transmitted so as to allow a limited time for decryption.

In some examples, the server may be configured to generate the first challenge based on one or more factors. For example, the one or more factors may include a version number returned in the first read, and a determination of a predetermined type of transaction. For example, the first challenge may be generated based on the version number obtained in the first read. For example, the server may be configured to determine if a transaction associated with the authentication request is a high-risk transaction. The server may be configured to determine if the transaction is high-risk based on evaluation of one or more parameters, including one or more selected from the group of account data, transaction history data, transaction amount, previous time stamps associated with same or similar transactions, prior user authentication attempts and results, abnormal or suspicious geographic locations, abnormal or suspicious fraudulent merchants, and/or any combination thereof.

At block 520, the method 500 may include decrypting the encrypted first challenge. For example, the card may be configured to decrypt the encrypted first challenge received from the application of the client device. In some examples, the first challenge may be unencrypted and transmitted by the application of the client device, and received by the one or more processors of the card. The one or more processors of the card may be configured to combine the first challenge with one or more private card keys in such a manner that either a secret key holder, such as the server associated with an issuer of the card, may validate that it was combined correctly or via public key verification.

At block 525, the method 500 may include generating a second cryptogram. The response may be a second response and comprise a second cryptogram that incorporates the first challenge into the calculation, which may be combined with the one or more private card keys or as part of the message being signed. The card may be configured to encrypt the second cryptogram prior to its transmission. In some examples, the card may be configured to perform one or more logical operations, e.g., AND, OR, XOR, NOT, of the random number with the response prior to the encryption of the second cryptogram.

At block 530, the method 500 may include transmitting, responsive to the command-application protocol data unit, a second response including the second cryptogram. The card may be configured to transmit the decrypted first challenge to the application of the client device as part of a response-application protocol data unit (R-APDU). The response may also include the random number, such as the secret salt, that is transmitted for verification by comparison with a reference random number or secret salt by the server. The card may be configured to transmit, after entry into one or more communication fields of any device, data, such as the second cryptogram. For example, the card may be configured to transmit, after a second entry into a first communication field of the device, the second response including second cryptogram and random number. Without limitation, each entry may be associated with a tap, a swipe, a wave, and/or any combination thereof.

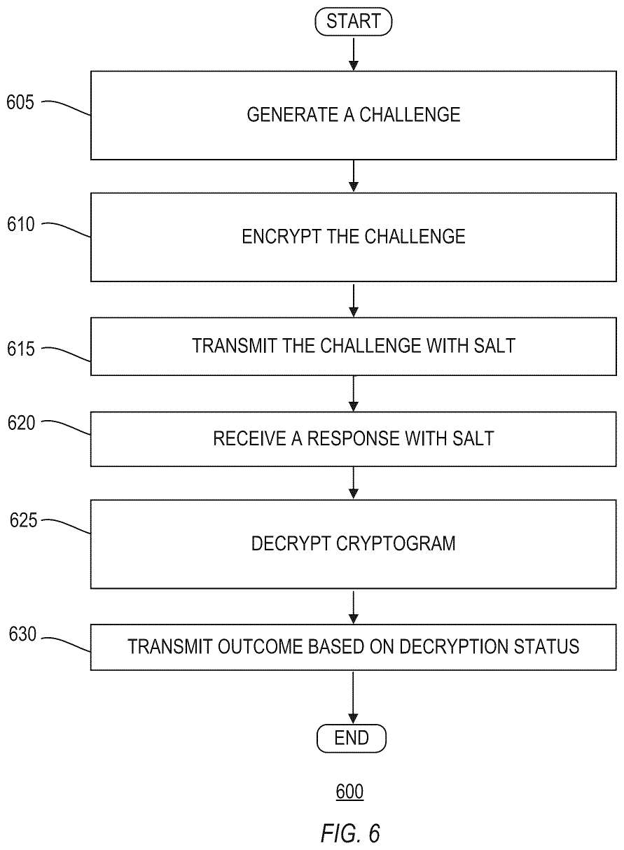

FIG. 6 depicts a method 600 of authentication according to an exemplary embodiment. FIG. 6 may reference the same or similar components of system 100, first device 200 of FIG. 2A and FIG. 2B, method 300 of FIG. 3, sequence diagram 400 of FIG. 4, and method 500 of FIG. 5.

At block 605, the method 600 may include generating a challenge. For example, the server may be configured to generate the challenge. In some examples, the application of the device may be configured to generate the challenge. Moreover, the server or application of the device may be configured to generate a random number, such as a secret salt, that is associated with a transaction and also included with the transmitted challenge. The random number may be generated by the server or the application of the device and may be unique for each transaction. For example, the random number may comprise a string of bits with high entropy. In some examples, the random number may serve as an additional component in the MAC calculation, and include any length. In other examples, the random number may be the same length as the message for combining, such as the one or more logical operations including but not limited to, AND, OR, XOR, NOT.

In some examples, the server may be configured to generate the challenge based on one or more factors. For example, the one or more factors may include a version number associated with a card and returned in a read, and a determination of a predetermined type of transaction. For example, the challenge may be generated based on the version number obtained in the read. The server may be configured to determine if a transaction associated with the authentication request is a high-risk transaction. The server may be configured to determine if the transaction is high-risk based on evaluation of one or more parameters, including one or more selected from the group of account data, transaction history data, transaction amount, previous time stamps associated with same or similar transactions, prior user authentication attempts and results, abnormal or suspicious geographic locations, abnormal or suspicious fraudulent merchants, and/or any combination thereof.

The challenge may be associated with a predetermined time duration. Thus, the challenge may be time-limited. For example, the server may be configured to generate, after expiration of the predetermined time duration, one or more additional challenges that are each associated with respective predetermined time durations. For example, the server may be configured to generate, after expiration of the predetermined time duration, a second challenge associated with a second predetermined time duration. In this manner, a new encrypted challenge associated with a predetermined time duration may be generated and transmitted so as to allow a limited time for decryption.

At block 610, the method 600 may include encrypting the challenge. For example, the server may be configured to encrypt the challenge with a key, such as a symmetric key. In other examples, the application of the device may be configured to encrypt the challenge with the key. For example, the challenge may be combined with a unique identifier of the card, a counter of the card, and one or more logical operations, including but not limited to, AND, OR, XOR, NOT. In some examples, the challenge may be encrypted with one or more symmetric keys. For example, the card may include its own symmetric key that is also known by the server or the application comprising instructions for execution on the device, or may be derived via key diversification. In some examples, one or more unique derived keys may be generated based on combining one or more secret master keys with the unique identifier of the card. In the card and the server or the application, the symmetric key be independently derived from a master key, and is thus never transmitted. In other examples, the first challenge may be encrypted by a private key of the card, in which a transmitted public key may be configured to decrypt the first challenge that was encrypted by the private key.

Regarding the key diversification, and without limitation, the card may include a card key, such as a diversified master key, and the server may include its own server key, such as a master key. The card may be configured to generate a diversified key using the diversified master key, one or more cryptographic algorithms, and a counter value. The card may be configured to generate a cryptographic result including the counter value using the one or more cryptographic algorithms and the diversified key. The card may be configured to encrypt transmission data using the one or more cryptographic algorithms and the diversified key to yield encrypted transmission data. The encrypted transmission data and cryptographic result may be transmitted, for example to server, by the card for decryption.

The server may be configured to generate an authentication diversified key based on the server master key and a unique identifier. The server may be configured to generate a session key based on the authentication diversified key. The server may be configured to decrypt encrypted transmission data and validate the received cryptographic result using the one or more cryptographic algorithms and the session key.

At block 615, the method 600 may include transmitting the challenge. For example, the server may be configured to transmit the encrypted challenge to the application of the client device. In some examples, the server may be configured to transmit the encrypted challenge based on the version number received from the card or the application of the device. In other examples, the application of the device may be configured to transmit the challenge. For example, the application of the client device may be configured to transmit the encrypted challenge as part of command-application protocol data unit (C-APDU) to the card.

At block 620, the method 600 may include receiving a response. For example, the server may be configured to receive a response. In other examples, the application of the device may be configured to receive the response. The response may be transmitted responsive to the transmitted challenge. The server may be configured to receive the response including a cryptogram from the card. In some examples, the server may be configured to receive the response including the cryptogram from the application of the client device.

The card may be configured to decrypt the encrypted challenge received from the application of the client device. In some examples, the first challenge may be unencrypted and transmitted by the application of the client device, and received by the one or more processors of the card. The one or more processors of the card may be configured to combine the first challenge with one or more private card keys in such a manner that either a secret key holder, such as the server associated with an issuer of the card, may validate that it was combined correctly or via public key verification. When the first challenge is encrypted, the card may be configured to transmit the decrypted challenge to the application of the client device as part of a response-application protocol data unit (R-APDU). The response may be a response and comprise a cryptogram. The card may be configured to encrypt the cryptogram prior to its transmission. The response may also include the random number, such as the secret salt, that is transmitted for verification by comparison with a reference random number or secret salt by the server. In some examples, the card may be configured to perform one or more logical operations, e.g., AND, OR, XOR, NOT, of the random number with the response prior to the cryptogram encryption. The card may be configured to transmit, after entry into one or more communication fields of any device, data, such as the cryptogram. For example, the card may be configured to transmit, after an entry into a communication field of the device, the cryptogram. Without limitation, each entry may be associated with a tap, a swipe, a wave, and/or any combination thereof.

At block 625, the method 600 may include decrypting the cryptogram. For example, the server may be configured to decrypt the received cryptogram from the response. In other examples, the application of the device may be configured to decrypt the received cryptogram from the response. The server may be configured to authenticate the response by validating the cryptogram. For example, the server may be configured to decrypt the cryptogram.

At block 630, the method 600 may include transmitting an outcome based on a status of decryption of the cryptogram. For example, based on a determination of an outcome of the decryption of the cryptogram, the server may be configured to transmit one or more results to the application of the client device. The one or more results may be indicative of the decryption status. In some examples, the server may be configured to transmit a successful authentication message if the cryptogram is validated. For example, the server may be configured to transmit the successful authentication message to the application of the client device. In other examples, the server may be configured to transmit an unsuccessful authentication message if the cryptogram is not validated. For example, the server may be configured to transmit the unsuccessful authentication message to the application of the client device. If the cryptogram is not validated, the server may terminate the authentication process. In another example, the server may be configured to resume the authentication process by, without limitation, resending the authentication request, or generating and encrypting and transmitting a different challenge.

It is further noted that the systems and methods described herein may be tangibly embodied in one of more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

In the preceding specification, various embodiments have been described with references to the accompanying drawings. It will, however, be evident that various modifications and changes may be made thereto, and additional embodiments may be implemented, without departing from the broader scope of the invention as set forth in the claims. The specification and drawings are accordingly to be regarded as an illustrative rather than restrictive sense.

We claim:

1. An authentication server, comprising:
a processor; and
a memory, wherein the processor is configured to:
transmit an authentication request;
receive a first response that is responsive to the authentication request, the first response comprising a first cryptogram;
generate a first challenge based on the first response;
encrypt the first challenge with a symmetric key;
transmit the first challenge;
receive a second response that is responsive to the first challenge, the second response comprising a second cryptogram; and
authenticate the second response.

2. The authentication server of claim 1, wherein the first response is generated based on a first read of a tag.

3. The authentication server of claim 1, wherein the first challenge is associated with a first predetermined time duration.

4. The authentication server of claim 3, wherein the processor is further configured to generate, after expiration of the first predetermined time duration, a second challenge associated with a second predetermined time duration.

5. The authentication server of claim 1, wherein the processor is further configured to generate the first challenge based on a determination of a predetermined type of transaction.

6. The authentication server of claim 1, wherein the processor is further configured to receive a public key and a version number.

7. The authentication server of claim 6, wherein the first challenge is transmitted based on the version number.

8. The authentication server of claim 1, wherein the processor is further configured to generate a random number that is included with the first challenge, the random number associated with a transaction.

9. A method of authentication, the method comprising the steps of:
transmitting an authentication request;
receiving a first response that is responsive to the authentication request, the first response comprising a first cryptogram;
generating a first challenge based on the first response;
encrypting the first challenge with a symmetric key;
transmitting the first challenge;
receiving a second response that is responsive to the first challenge, the second response comprising a second cryptogram; and
authenticating the second response.

10. The method of claim 9, wherein the first response is generated based on a first read of a tag.

11. The method of claim 9, wherein the first challenge is associated with a first predetermined time duration.

12. The method of claim 11, further comprising generating, after expiration of the first predetermined time duration, a second challenge associated with a second predetermined time duration.

13. The method of claim 9, further comprising generating the first challenge based on a determination of a predetermined type of transaction.

14. The method of claim 9, further comprising receiving a public key and a version number.

15. The method of claim 14, wherein the first challenge is transmitted based on the version number.

16. The method of claim 9, further comprising generating a random number that is included with the first challenge, the random number associated with a transaction.

17. The method of claim 9, further comprising decrypting the second response including a secret salt.

18. The method of claim 9, further comprising transmitting, based on determining an outcome of decryption status of the second cryptogram, one or more messages indicative of the decryption status.

19. The method of claim 9, wherein the first cryptogram is received via a near field communication data exchange format (NDEF) read.

20. A computer readable non-transitory medium comprising computer executable instructions that, when executed on a processor, perform procedures comprising the steps of:
transmitting an authentication request;
receiving a first response that is responsive to the authentication request, the first response comprising a first cryptogram;
generating a first challenge based on the first response;
encrypting the first challenge with a symmetric key;
transmitting the first challenge;
receiving a second response that is responsive to the first challenge, the second response comprising a second cryptogram; and
authenticating the second response.
